(19) United States
(12) Patent Application Publication
(10) Pub. No.: US 2019/0273887 A1
(43) Pub. Date: Sep. 5, 2019

(54) INTELLIGENT VIDEO SURVEILLANCE SYSTEM

(71) Applicant: Otis Elevator Company, Farmington, CT (US)

(72) Inventors: Hiromitsu Miyajima, Inzai (JP); Atsushi Yamada, Narita-shi (JP)

(21) Appl. No.: 15/910,134

(22) Filed: Mar. 2, 2018

(51) Int. Cl. H04N 5/77; H04N 7/18; H04N 9/79

(52) U.S. Cl. CPC H04N 5/77; H04N 9/7921; H04N 7/185

(57) ABSTRACT

The video surveillance system for an elevator includes a video camera arranged in an elevator car to capture video data, a video recorder unit for recording the captured video data on at least one storage device, and an elevator controller connected to the video recorder unit for transmitting signals indicative of elevator door status. The video recorder unit is configured to detect a failure of the video camera by detecting the absence of a video image change in response to a door status change.

### TECHNICAL FIELD

The present invention relates generally to video surveillance. More particularly, the present invention relates to an intelligent video surveillance system that can detect failures in the system.

### BACKGROUND ART

Various video surveillance systems are used to monitor conditions in an elevator car to maintain passenger safety and security. Video surveillance system generally includes at least one video camera arranged within an elevator car to capture video data and a video recorder unit for storing the captured video data for later use such as traffic data analysis, accident records, evidences, etc.

Basically, a failure may occur in a video camera or a video recorder unit. In many cases, such failures may be unrecognized until a mechanic checks the video surveillance system on site at the time of a periodical inspection.

Furthermore, in case of failure in the video camera or the video recorder unit, video data may not be recorded for a certain amount of time, which may cause serious damage to identifying crime, etc.

Another drawback of such systems is that it takes time to identify the component causing problems in the video surveillance system and also takes time to repair the component since it is not possible to prepare replacement parts on site.

Accordingly, it would be desirable to provide an improved video surveillance system for an elevator that can automatically carry out fault diagnoses and identify the component causing problems in the system without the need for an external service.

### SUMMARY OF INVENTION

According to one aspect of the present invention, a video surveillance system for an elevator is disclosed. The video surveillance system includes a video camera arranged in an elevator car to capture video data, a video recorder unit for recording the captured video data on at least one storage device, and an elevator controller connected to the video recorder unit for transmitting signals indicative of elevator door status. The video recorder unit is configured to detect a failure of the video camera by detecting the absence of a video image change in response to a door status change.

In some embodiments, the video recorder unit is configured to transmit an alert via the elevator controller to a remote monitoring system in response to the detection of the failure of the video camera.

In some embodiments, at least one storage device includes a primary storage device and a secondary storage device, and the video recorder unit is configured to record the captured video data on the secondary storage device if the primary storage device has failed and configured to transmit an alert via the elevator controller to a remote monitoring system indicating that the primary storage device has failed.

In some embodiments, the elevator controller is configured to periodically exchange a keep-alive message and a response message with the video recorder unit and detect a failure of the video recorder unit by detecting the absence of response messages a predetermined number of times consecutively, and configured to transmit an alert to a remote monitoring system in response to the detection of the failure of the video controller.

In some embodiments, the storage device is selected from a flash memory device, a hard disk drive, optical storage, and cloud storage.

In some embodiments, the storage device is a flash memory device.

According to another aspect of the present invention, a method of detecting a failure of a video surveillance system for an elevator is disclosed. The video surveillance system includes a video camera arranged in an elevator car to capture video data, a video recorder unit for recording the captured video data on at least one storage device, and an elevator controller connected to the video recorder unit for transmitting signals indicative of elevator door status. The method includes checking whether the at least one storage device is available, checking whether the video recorder unit is connected to the elevator controller, detecting a video image change in response to a door status change associated with the opening and closing of the elevator door, and determining a failure of the video camera by detecting the absence of a video image change in response to a door status change.

In some embodiments, the method further includes transmitting an alert via the elevator controller to a remote monitoring system in the event of the failure of the video camera.

In some embodiments, the at least one storage device includes a primary storage device and a secondary storage device, and checking whether the at least one storage device is available includes periodically generating a file including a time stamp, writing the file in the primary storage device, reading the written file from the primary storage device, comparing the written time stamp with the original time stamp, detecting a failure of the primary storage device if the written time stamp does not coincide with the original time stamp, and switching to the secondary storage device and transmitting an alert via the elevator controller to a remote monitoring system in response to the detection of the failure of the primary storage device.

In some embodiments, checking whether the video recorder unit is connected to the elevator controller includes periodically exchanging a keep-alive message and a response message between the elevator controller and the video recorder unit, detecting a failure of the video recorder unit if the elevator controller detects the absence of response messages a predetermined number of times consecutively, and transmitting an alert from the elevator controller to a remote monitoring system in response to the detection of the failure of the video recorder unit.

In some embodiments, exchanging a keep-alive message and a response message is performed at intervals of one minute.

In some embodiments, detecting a video image change includes tracking the movement of the elevator door and recognizing an image change amount of the elevator door corresponding to the detection area of the video camera.

These and other aspects of this disclosure will become more readily apparent from the following description and the accompanying drawings, which can be briefly described as follows.

### BRIEF DESCRIPTION OF DRAWINGS

FIG. 1 is a block diagram of a video surveillance system according to an embodiment of the present invention.

FIG. 2 is a flow diagram illustrating a method for detecting a failure of the video recorder unit, performed by an elevator controller.

FIG. 3 is a sequence diagram showing the keep-alive communication between the elevator controller and the video recorder unit of the present invention.

FIG. 4 is a flow diagram illustrating a method for detecting a failure of a storage device, performed by the video recorder unit of the present invention.

FIG. 5 is a flow diagram illustrating a method for detecting a failure of a video camera, performed by the video recorder unit of the present invention.

### DESCRIPTION OF EMBODIMENTS

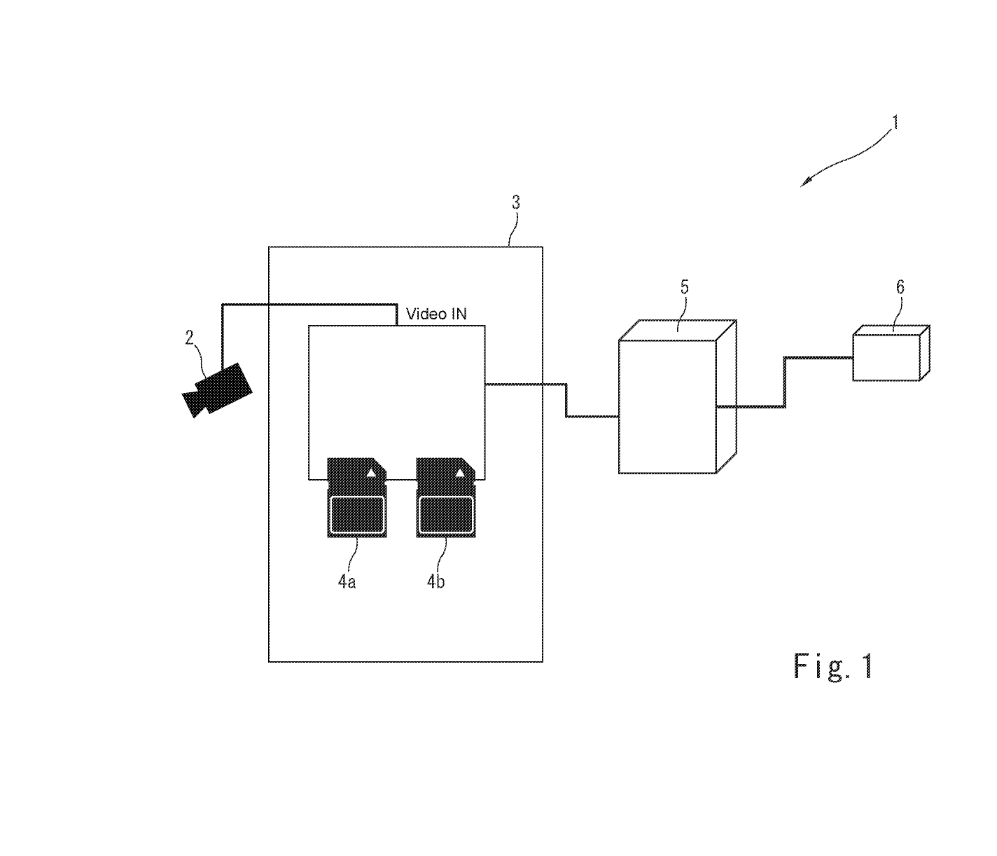

FIG. 1 illustrates a block diagram showing one possible arrangement of components of a video surveillance system for an elevator in accordance with the present invention. Video surveillance system 1 includes at least one video camera 2 arranged in an elevator car to capture video data of passengers, a video recorder unit 3 for recording the captured video data on a storage device 4, and an elevator controller 5 configured to transmit signals indicative of door status and keep-alive messages to the video recorder unit 3 and receive response messages from the video recorder unit 3. As will be described in detail below, algorithm for a detection of a failure of the video recorder unit 3 is implemented in the elevator controller 5.

The video recorder unit 3 is generally installed in the elevator car; however it may be installed at various locations outside of the elevator car, as long as the video recorder unit 3 is connected to both the video camera 2 and the elevator controller 5. The video recorder unit 3 includes at least one storage device 4. The storage device 4 may be any recording media such as flash memory device, hard disk drive, optical storage, cloud storage, etc. However, flash memory device such as SD card is advantageous in terms of its portability, easy replaceability and relatively large storage volume. In FIG. 1, the video recorder unit 3 is configured to include two SD cards 4a, 4b.

The elevator controller 5 is generally provided in a machine room above the top floor of a building or provided in an operation control panel arranged at any specific location in a building. The elevator controller 5 is connected to a remote monitoring system 6 via communication lines for transmitting a message in the event of a failure of the video surveillance system 3.

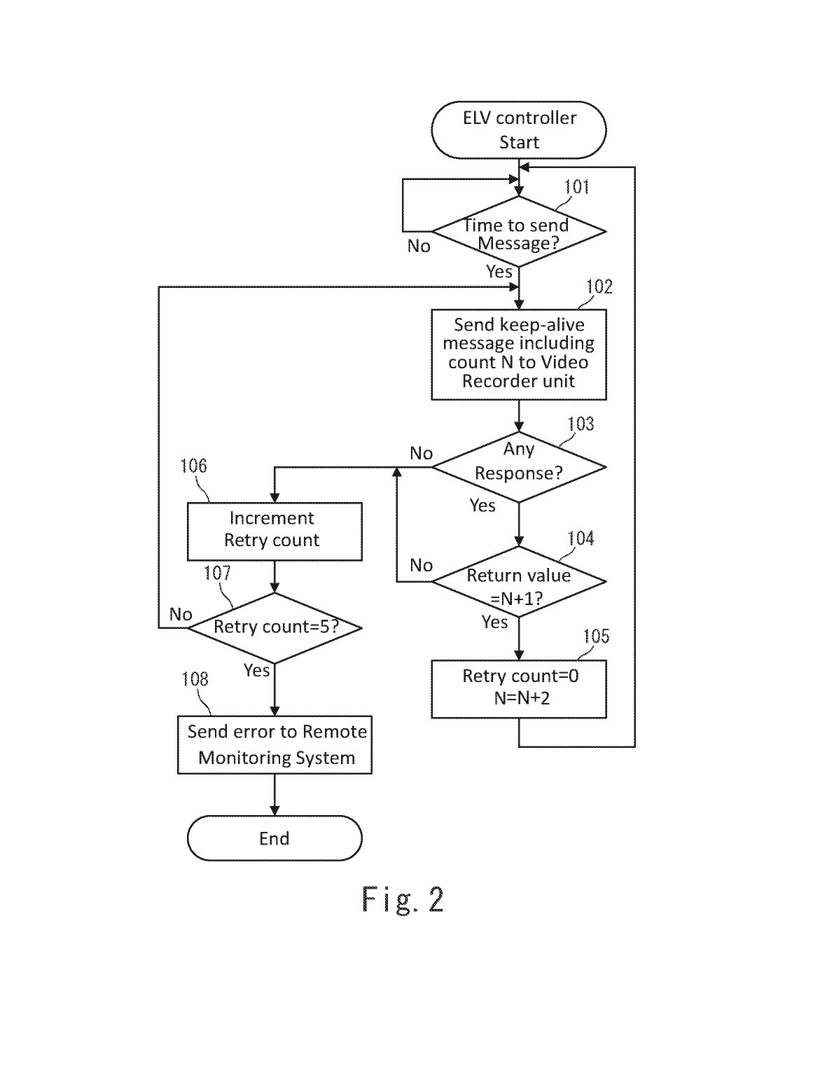

In the following, a method of detecting a failure of a component in the video surveillance system 1 will be described with reference to FIG. 2 to FIG. 5.

FIG. 2 is a flowchart diagram of exemplary operations performed by the elevator controller 5 for carrying out fault diagnosis on the video recorder unit 3. The process begins at step 101 where the elevator controller 5 checks to monitor the health of video recorder unit 3 at predetermined intervals, e.g. at intervals of one minute. The process continues to loop until the predetermined time has been reached. When the predetermined time has been reached at step 101, flow proceeds to step 102 where the elevator controller 5 generates a keep-alive message including a count N and transmits the message to the video recorder unit 3. The video recorder unit 3 is configured to exchange keep-alive message and response message with the elevator controller 5. If the video recorder unit 3 receives the keep-alive message including a count N, the video recorder unit 3 immediately generates a response message by incrementing the count by one (N=N+1) and transmits back to the elevator controller 5. At step 103, the elevator controller 5 checks to see if there is any response message received from the video recorder unit 3. If a response message is received, flow proceeds to step 104 to check whether the response message includes a return value of N+1. If the response message includes a return value of N+1, the elevator controller 5 determines that the video recorder unit 3 is functioning normally. Flow then proceeds to step 105 where the keep-alive message count N is incremented by two (N=N+2) and returns to step 101 to repeat process. As a result, the subsequent keep-alive message generated at step 102 includes a count N+2.

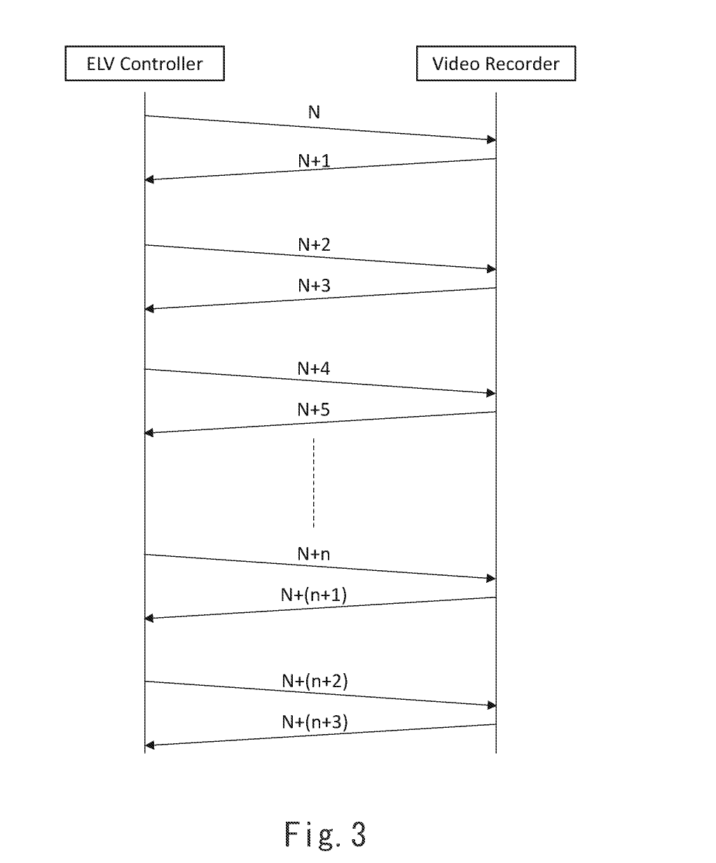

Here, referring to FIG. 3, the keep-alive communication between the elevator controller 5 and the video recorder unit 3 is shown in a sequence diagram. It can be seen that the elevator controller 5 sends a keep-alive message N, N+2, N+4, . . . , N+(n+2) to the video recorder unit 3 at predetermined intervals, e.g. every one minute, and that the video recorder 3 immediately sends back a response message N+1, N+3, N+5, . . . , N+(n+3), respectively, to the elevator controller 5, e.g. within one second. It should be understood that the frequency setting for exchanging a keep-alive message and a response message can be set or modified appropriately by a mechanic.

Referring back to step 103 in FIG. 2, if the elevator controller 5 does not receive any response message from the video recorder unit 3, flow proceeds to step 106 where the elevator controller 5 increments a retry count by one and continues with step 107 to check whether the retry count reaches five (5). If not, the process returns to step 102 to repeat process. In a retry sending a keep-alive message, if the elevator controller 5 successfully received a response message having a corresponding return value at step 104, flow then proceeds to step 105 to reset the retry count to zero in addition to incrementing the keep-alive message count by two, followed by returning to step 101 to repeat process.

On the other hand, if the retry count reaches five (5) at step 107, i.e., if the elevator controller 5 has not received a response message five consecutive times, the elevator controller 5 determines that the video recorder unit 3 has failed. The elevator controller 5 immediately transmits an alert to the remote monitoring system 6 for an inspection. Following the execution of step 108, the process completes and the elevator controller 5 will wait another set period of time to restart this process.

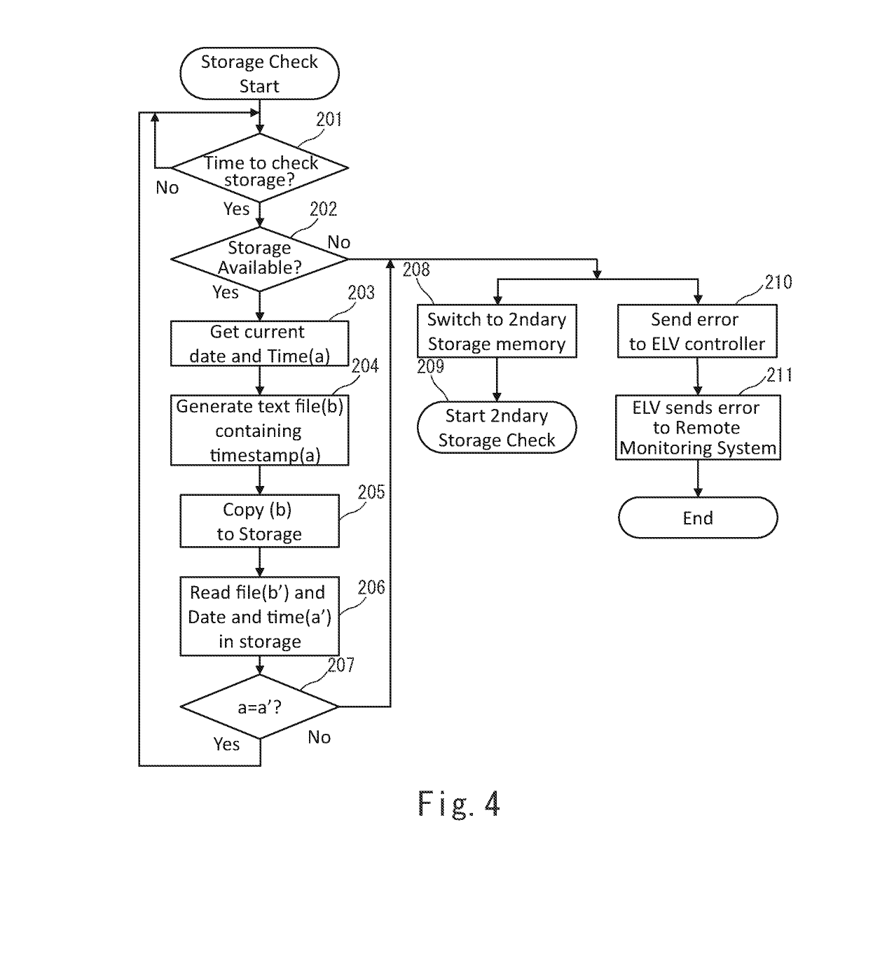

FIG. 4 is a flow diagram illustrating a method for detecting a failure of at least one storage device 4. In one embodiment, the video recorder unit 3 has two storage devices 4, i.e. a primary storage device 4a for default storage and a secondary storage device 4b for backup storage. This process may be performed by the video recorder unit 3. The process begins at step 201 where the video recorder unit 3 periodically checks to monitor the health of the default or the primary storage device 4a. Subsequently, at step 202, the video recorder unit 3 checks to see if the primary storage device 4a is available, i.e. the video recorder unit 3 checks to see if it establishes connection with the primary storage device 4a. If the primary storage device 4a is available, flow proceeds to step 203 where the video recorder unit 3 generates a time stamp (a) including a current date and time and then generates a text file (b) containing the time stamp (a) at step 204. At step 205, the video recorder unit 3 writes the original text file (b) in the primary storage unit 4a. Subsequently, at step 206, the video recorder unit 3 reads out the written text file (b′) including the time stamp (a′) from the primary storage device 4a and then, at step 207, compares the written time stamp (a′) with the original time stamp (a) in the video recorder unit 3. At step 207, if the written time stamp (a′) coincides with the original time stamp (a), the video recorder unit 3 determines that the primary storage device 4a is functioning normally and flow proceeds to step 201 to repeat process.

In contrast, if the written time stamp (a′) does not coincide with the original time stamp (a) at step 207, the video recorder unit 3 determines that a failure occurs in the primary storage device 4a. Flow then proceeds to step 208 where the video recorder unit 3 automatically switches to the secondary storage device 4b to take over the functions of the primary storage device 4a. Thereafter, flow proceeds to step 209 to restart this process to further check the health of the secondary storage device 4b, while at the same time, flow proceeds to step 210 where the video recorder unit 3 sends a message to the elevator controller 5 that the primary storage device 4a has failed. In response to receiving the message indicating a failure of the primary storage device 4a, the elevator controller 5 immediately transmits an alert to the remote monitoring system 6 for an inspection (step 211). Following the execution of step 211, the process completes and the video recorder unit 3 will wait another set period of time to restart this process.

Again referring to step 202, if the primary storage device 4a is unavailable for a reason other than a failure of the primary storage device 4a itself, e.g. the primary storage device 4a is disconnected from the video recorder unit 3, flow proceeds to steps 208 and 210 in a similar manner as in the case of a storage failure, to send an alert message to the remote monitoring system 6 while switching to the backup or the secondary storage device 4b.

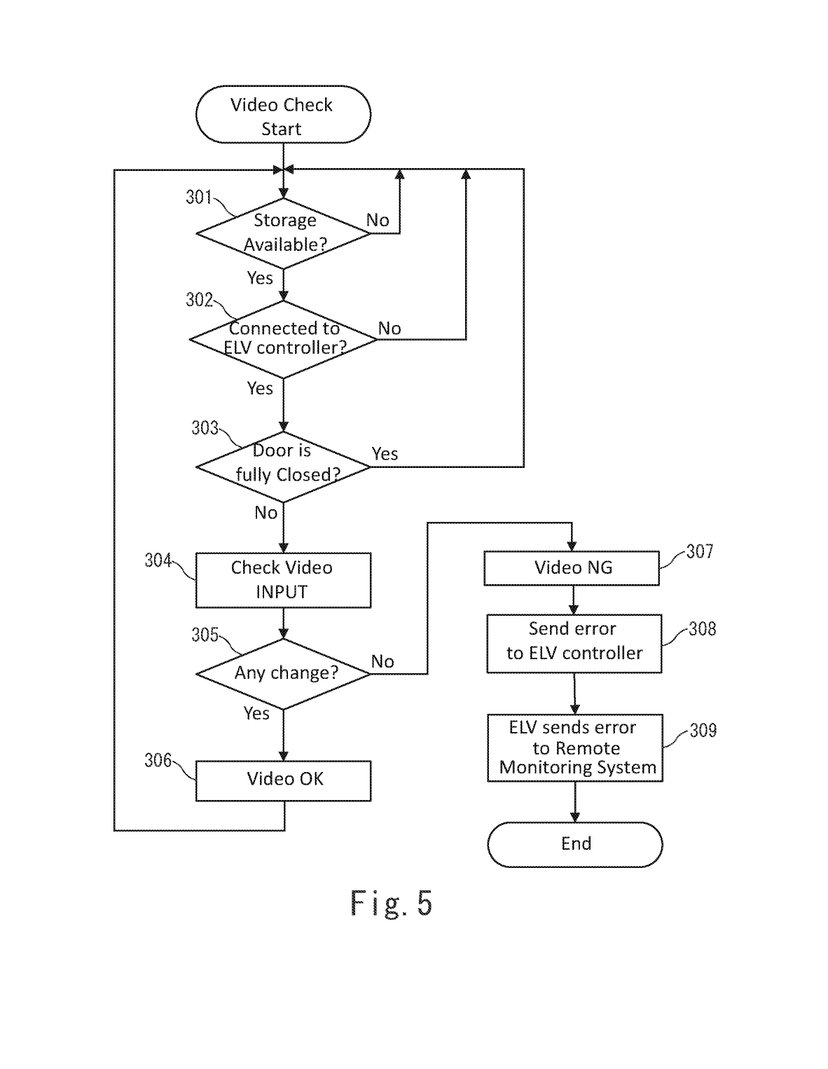

FIG. 5 is a flow diagram illustrating a method for detecting a failure of a video camera 2 which is performed by the video recorder unit 3. The process begins at step 301 where the video recorder unit 3 checks to see if any storage device 4 is available, which is determined based on the algorithm shown in FIG. 4. If there is no storage device 4 available at step 301, the process continues to loop until the video recorder unit 3 finds any storage device available. If there is any storage device 4 available at step 301, flow proceeds to step 302 where the video recorder unit 3 further checks to see if the video recorder unit 3 is connected to the elevator controller 5. The connection between the video recorder unit 3 and the elevator controller 5 can be detected by performing the algorithm shown in FIG. 2. If the video recorder unit 3 is not connected to the elevator controller 5, the process continues to loop until the video recorder unit 3 establishes connection with the elevator controller 5. At step 302, once the connection between the video recorder unit 3 and the elevator controller 5 is confirmed, flow proceeds to step 303 where the video recorder unit 3 determines whether the elevator door is fully closed. The door status signal can be obtained from the elevator controller 5. At step 303, if the door is fully closed, then flow returns to step 301 to repeat process. If the door is NOT in a fully closed position, i.e. if the door is opening, fully opened or closing, the video recorder unit 3 checks the video input at step 304, followed by determining whether the video image has changed in response to a door status change (step 305). The video image change can be detected by using a motion detection technique. For example, the video image change can be detected by tracking the movement of the elevator door and recognizing an image change amount of the elevator door corresponding to the detection area. In another example, the video image change can be detected by comparing the current video image with a reference image of the elevator door. In any case, the health of the video camera 2 can be monitored by detecting a video image change in response to a door status change associated with the opening and closing of the elevator door. It should be understood that the video image change may be detected by utilizing any known technique.

At step 305, if the video recorder unit 3 detects any video image change in response to a door status change, the video recorder unit 3 determines that the video camera 2 is operating normally. Following the execution of step 306, the algorithm returns to step 301 to repeat process.

In contrast, at step 305, if the video recorder unit 3 does not recognize any video image change despite the door status change, the video recorder unit 3 determines that a fault has occurred in the video camera 2 at step 307. In response to detecting a failure of the video camera 2 at step 307, the video recorder unit 3 immediately sends a message to the elevator controller 5 that the video camera 2 has failed (step 308) and, in turn, the elevator controller 5 transmits an alert to the remote monitoring system 6 for an inspection (step 309). Following the execution of step 309, the process completes and the video recorder unit 3 will wait another set period of time to restart this process.

According to the present invention, the video surveillance system 1 is configured to automatically detect a failure or malfunction of a component in the system and immediately report the failure to the remote elevator monitoring system. Thus, the video surveillance system of the present invention can minimize downtime and thereby improving elevator service performance.

While the present invention has been particularly shown and described with reference to the exemplary embodiments as illustrated in the drawings, it will be recognized by those skilled in the art that various modifications may be made without departing from the spirit and scope of the invention as disclosed in the accompanying claims.

1. A video surveillance system for an elevator comprising:
a video camera arranged in an elevator car to capture video data;
a video recorder unit for recording the captured video data on at least one storage device; and
an elevator controller connected to the video recorder unit for transmitting signals indicative of elevator door status,
wherein the video recorder unit is configured to detect a failure of the video camera by detecting the absence of a video image change in response to a door status change.

2. The system of claim 1, wherein the video recorder unit is configured to transmit an alert via the elevator controller to a remote monitoring system in response to the detection of the failure of the video camera.

3. The system of claim 1, wherein the at least one storage device includes a primary storage device and a secondary storage device, and the video recorder unit is configured to record the captured video data on the secondary storage device if the primary storage device has failed and configured to transmit an alert via the elevator controller to a remote monitoring system indicating that the primary storage device has failed.

4. The system of claim 1, wherein the elevator controller is configured to periodically exchange a keep-alive message and a response message with the video recorder unit and detect a failure of the video recorder unit by detecting the absence of response messages a predetermined number of times consecutively, and configured to transmit an alert to a remote monitoring system in response to the detection of the failure of the video controller.

5. The system of claim 1, wherein the storage device is selected from a flash memory device, hard disk drive, optical storage and cloud storage.

6. The system of claim 5, wherein the storage device is a flash memory device.

7. A method of detecting a failure of a video surveillance system for an elevator, the video surveillance system including a video camera arranged in an elevator car to capture video data, a video recorder unit for recording the captured video data on at least one storage device, and an elevator controller connected to the video recorder unit for transmitting signals indicative of elevator door status, the method comprising the steps of:
checking whether the at least one storage device is available;
checking whether the video recorder unit is connected to the elevator controller;
detecting a video image change in response to a door status change associated with the opening and closing of the elevator door; and
determining a failure of the video camera by detecting the absence of a video image change in response to a door status change.

8. The method of claim 7, further comprising the step of:
transmitting an alert via the elevator controller to a remote monitoring system in the event of the failure of the video camera.

9. The method of claim 7, wherein the at least one storage device includes a primary storage device and a secondary storage device, and the step of checking whether the at least one storage device is available includes:
periodically generating a file including a time stamp;
writing the file in the primary storage device;
reading the written file from the primary storage device;
comparing the written time stamp with the original time stamp;
detecting a failure of the primary storage device if the written time stamp does not coincide with the original time stamp; and
switching to the secondary storage device and transmitting an alert via the elevator controller to a remote monitoring system in response to the detection of the failure of the primary storage device.

10. The method of claim 7, wherein the step of checking whether the video recorder unit is connected to the elevator controller includes:
periodically exchanging a keep-alive message and a response message between the elevator controller and the video recorder unit;
detecting a failure of the video recorder unit if the elevator controller detects the absence of response messages a predetermined number of times consecutively; and
transmitting an alert from the elevator controller to a remote monitoring system in response to the detection of the failure of the video recorder unit.

11. The method of claim 10, wherein the step of exchanging a keep-alive message and a response message is performed at intervals of one minute.

12. The method of claim 7, wherein the step of detecting a video image change includes tracking the movement of the elevator door and recognizing an image change amount of the elevator door corresponding to the detection area of the video camera.
